(19) United States
(12) Patent Application Publication
(10) Pub. No.: US 2024/0200269 A1
(43) Pub. Date: Jun. 20, 2024

(54) METHOD AND DEVICE FOR MONITORING AND REGULATING A WALL THICKNESS DISTRIBUTION IN A PRODUCTION PROCESS OF CONTAINERS COMPRISING FIBERS, CONTAINER COMPRISING FIBERS AND DEVICE FOR PRODUCING A CONTAINER COMPRISING FIBERS

(71) Applicant: Krones AG, Neutraubling (DE)

(72) Inventors: Daniel Peter, Hemau (DE); Frank Winzinger, Regensburg (DE)

(21) Appl. No.: 18/543,616

(22) Filed: Dec. 18, 2023

(30) Foreign Application Priority Data
Dec. 20, 2022 (DE) 102022134118.6

(51) Int. Cl. D21G 9/00; D21J 3/10; G01B 21/08

(52) U.S. Cl. CPC D21G 9/0036; D21G 9/0018; D21J 3/10; G01B 21/08

(57) ABSTRACT

The disclosure provides a method for monitoring and regulating a wall thickness distribution in a production process of containers, the method comprising: producing a container comprising fibers by a production process comprising a plurality of production steps, which uses a fiber-containing pulp, measuring a wall thickness distribution of the produced container, comparing the measured wall thickness distribution with a target wall thickness distribution, when there is a deviation of the measured from the target wall thickness distribution, regulating at least one of the plurality of production steps. The disclosure provides a container comprising fibers being produced by the method, to a device for monitoring and regulating a wall thickness distribution in a production process of containers comprising fibers by the method, and to a device for producing a container comprising fibers.

### CROSS REFERENCE TO RELATED APPLICATION

The present application claims priority to German Patent Application No. 10 2022 134 118.6 filed on Dec. 20, 2022. The entire contents of the above-listed application are hereby incorporated by reference for all purposes.

### TECHNICAL FIELD

The disclosure relates to a method and a device for monitoring and regulating a wall thickness distribution in a production process of containers comprising fibers, a container comprising fibers and a device for producing a container comprising fibers.

### BACKGROUND

It is known that containers comprising fibers should have a sufficient wall thickness for handling in general, for being filled with product, and for example transport and/or storage of the containers filled with product. Containers comprising fibers may be produced in various ways, for example with a pulp coating process or with a spray head that distributes pulp or dry fibers in a mold. Pressing can occur in the same mold or in another mold.

### SUMMARY

### Object

The object of the disclosure is to provide a method and a device for monitoring and regulating a wall thickness distribution in a production process of containers comprising fibers, a container comprising fibers and a device for producing a container comprising fibers, whereby a required quality of a produced container comprising fibers can be achieved.

### Achievement

The object is achieved by the method and the device for monitoring and regulating a wall thickness distribution in a production process of containers comprising fibers, containers comprising the fibers and a device for producing a container comprising fibers as described herein.

The method according to the disclosure for monitoring and regulating a wall thickness distribution in a production process of containers comprising fibers comprises producing a container comprising fibers by means of a production process comprising a plurality of production steps that uses a fiber-containing pulp or dry fibers, measuring a wall thickness distribution of the produced container, comparing the measured wall thickness distribution with a target wall thickness distribution and, when there is a deviation of the measured wall thickness distribution from the target wall thickness distribution, regulating at least one of the plurality of production steps. The wall thickness distribution can be measured by ultrasound, radar, resonance and/or capacitive sensors.

The method can run as an automatic procedure. The various steps of the process may be performed without the interaction of a human.

The measurement of the wall thickness distribution can occur, for example, by scanning. For example, for this purpose, a measuring finger can be pressed against an inner side of the container, and more or less at the same position outside the container, another measuring finger can be applied from the outside to the same wall section. The wall thickness can then be determined by the angle or another scale, e.g. as with a caliper.

The measurement of the wall thickness distribution can alternatively also be performed using ultrasonic waves or other methods. For example, the measurement can be made using electromagnetic radiation. In this regard, many types of radiation along the spectrum are conceivable. Depending on the thickness of the wall, a measurement with light in the visible range would also be conceivable.

For example, the transmission of radiation through two walls of the container can be measured.

For example, a transmitter can be arranged on one side of the container, and a receiver can be arranged on the other side of the container. The receiver can determine a strength or a brightness of the radiation that has penetrated the container.

For example, it is also possible to measure alternatively or also only through one wall of the container by arranging one of the measuring tools (transmitter or receiver) in the interior of the container.

For example, the wall thickness can be measured at a plurality of height levels of the container.

For example, the wall thickness can be measured additionally or alternatively along a plurality of positions along the circumference of the container.

The plurality of measurements necessary for this purpose may be performed by the same measuring tool in succession, or by a plurality of measuring tools, for example simultaneously.

Measurement of the wall thickness can also be understood to mean the generation of a value or a signal which can be converted into a wall thickness, for example by means of a proportionality. If, for example, a receiver only outputs a current intensity which can be (but is not) converted using a factor to a wall thickness, this is also to be understood as measuring the wall thickness. These values are namely also already suitable for regulation.

A wall thickness can alternatively be determined by cutting through a container and optically recording the cut surface, for example by means of a camera and image evaluation. This can also be done several times at different height levels (“in rings”) or along different circumferential positions (“in cake slices”) of the container.

A wall thickness can also be determined by weighing individual components of the container.

A measurement can be taken in each produced container or randomly at intervals (e.g., a measurement per hour or per 1,000 produced container or a measurement per mold and per unit of time).

A measuring tool can, for example, measure containers of at least two, for example all, shapes.

If a production device comprises a plurality of molds, a regulation can be performed precisely for the mold in which the measured container was produced. An assignment to the specific mold can be determined by means of a controller. For example, this assignment can be made by recognizing a cavity number or by the sequence in which the containers are produced in the molds and transported to the measuring device.

The wall thickness can be measured in one embodiment during the production of the container. In this way, it can be possible to perform the regulation for the same container and to influence the wall thickness.

Alternatively, a wall thickness measurement of a container can be used only for the regulation of the production of other containers. The fibers may comprise lignin, banana leaves and/or quinine. The fibers may comprise, for example, cellulose fibers, fibers from coniferous woods, leafy woods and/or sycamores, and/or from grasses, reeds and/or bamboo or the like. The fibers may comprise silk threads, spider threads, algae, natural fibers (such as Danube silphie fibers, hemp, corn, cotton), banana peels, orange peels, grass, straw, potato starch or processed cow manure. Moreover, cellulose fibers which originate from a process by which they were artificially grown may be provided. These alternative materials may completely or partially replace wood as the base material for a fluid mass with fibers when there are material shortages.

The fibers may comprise fiber mixtures made of non-wood material, for example cotton, hemp and/or textile fibers.

For example, the fibers may comprise viscose fibers. A viscose fiber is an artificial fiber made of regenerated cellulose, wherein the viscose fibers have, as starting base, 100% cellulose treated in a multi-stage process. The viscose fibers may comprise a flat or cable-like structure, a trilobal shape or a double trilobal structure. The fibers may comprise a flat or hollow structure or a corrugated or rough outer surface.

Various types of fibers can also be used in combination. For example, fibers with different outer surfaces, and/or shapes, and/or a hollow structure, and/or a flat structure, and/or of different materials can be combined.

Due to the natural origin of the fibers, they can be biodegradable. In addition, they are sustainable and renewable.

The fibers may be used in a pulp. The pulp can be or comprise a mixture of water, for example with additives, and the fibers, or also a combination of the fibers.

A wall thickness distribution of a container can have a constant value of the wall thickness over the entire container, or the wall thickness distribution of a container can have different values of the wall thickness in different regions of the container. For example, the wall thickness in the region of a threaded strand (=thread) can be greater than in a neck region without a threaded strand. The wall thickness of a body region of the container can be smaller than a wall thickness in the base region.

The plurality of production steps of the production process of the container comprising fibers may comprise providing fiber-containing pulp, introducing the pulp into a mold and/or pressing the pulp in the mold to form the container comprising fibers. Additional production steps may be provided.

In the following, some control variables of regulation are described, the values of which may each be influenced upward or downward by a control.

A water content of the pulp and/or a temperature of the pulp may have an influence on the production of the container comprising fibers and its wall thickness distribution.

When the pulp is introduced into the mold, the inner surface of which can substantially correspond to a negative shape of the outer contour of the container to be produced, a temperature of the mold and/or a type of introduction of the pulp can have an influence on the production of the container comprising fibers and its wall thickness distribution. One type of introduction can comprise a coating and/or injection distribution of the pulp. For example, the coating and/or injection distribution can vary along a height and/or a circumference of the container to be produced such that an even distribution of the pulp can be achieved even in containers with a non-round cross-section. In various regions of the mold, even distributions of the pulp may exist with the same or different thicknesses. A non-round cross-section can be an oval, or elliptical, or triangular, or rectangular or generally polygonal cross-section. For example, the size of the cross-section can vary along the height of the container; this can also apply to a round cross-section.

When the pulp is introduced by means of a coating and/or injection distribution, one or more regions may also be provided where multi-coating or multi-injection molding of pulp can occur. Those regions which are not intended to experience multi-coating or multiple injection molding of pulp may be covered during coating and/or injection distribution.

There can be regions of the container which may be excluded during at least one coating or injection molding.

Along the height of the container, there can be an exclusion of coating from the weight of the pulp in that the coating mold is only partially filled. The upper region can then be excluded.

In particular, an option can be to rotate the mold about a horizontal axis between two coatings. In this way, both the mouthpiece region and the base region of the container may be coated several times, while a region in between can be coated less frequently. This can also be an independent disclosure.

The pulp can be pressed in the mold for shaping the container comprising fibers using different pressing pressures, for example also for different lengths of time. With a higher pressing pressure, the pulp can be compressed more by the compression than with a smaller pressing pressure. Accordingly, smaller wall thicknesses which may have a higher stability than less strongly compressed pulp may be achieved. In addition, by means of a higher pressing pressure, more of the water contained in the pulp can be pressed out so that the produced containers comprising fibers can be drier.

The regulation of at least one of the plurality of production steps can comprise regulating pressing force. By regulating the pressing force, a pressing pressure exerted in or on the mold for shaping the container comprising the fibers can be controlled. The pressing pressure can be applied with one or more press punch tools, with a balloon (see below) or with air pressure.

The regulation of pressing force can comprise a regulation of force of an electric motor for generating a pressing force. The electric motor can be connected to a lever that can transmit the pressing force.

The pressing force can act on at least a part of the container. For example, the pressing force can act on a wall of the mold into which the fiber-containing pulp can be introduced for shaping the container comprising fibers.

The regulation of force can comprise current regulation. By regulating the current, current consumption by the electric motor and accordingly the pressing force can be regulated.

The regulation of pressing force can comprise a regulation of a hydraulic pressure of an elastic inner tube. The hydraulic pressure can be regulated by an introduced quantity of compressed air. To be able to leave the compressed air in the elastic inner tube for a given period of time, a valve can be provided.

In addition to the pressing force, a pressing position can also be regulated in that, for example, the expansion of a balloon in the mold can be stopped at a certain expansion width.

The regulation of at least one of the plurality of production steps can comprise regulating a coating and/or injection distribution of the pulp. When the pulp is introduced by means of a coating and/or injection distribution, one or more regions may also be provided where multi-coating or multi-injection molding of pulp can occur. Those regions which are not intended to experience multi-coating or multiple injection molding of pulp may be covered during coating and/or injection distribution.

The coating and/or injection distribution can be regulated along a height and/or a circumference of the container. For example, the coating and/or injection distribution can vary along a height and/or a circumference of the container to be produced such that an even distribution of the pulp can be achieved even in containers with a non-round cross-section. In various regions of the mold, even distributions of the pulp may exist with the same or different thicknesses. A non-round cross-section can be an oval, or elliptical, or triangular, or rectangular or generally polygonal cross-section. For example, the size of the cross-section can vary along the height of the container; this can also apply to a round cross-section.

The regulation of at least one of the plurality of production steps can comprise a regulation of an embodiment of a hollow support ring. After pressing the fiber-containing pulp introduced into the mold, a tool with a protruding structure can be introduced into a mouth opening of the shaped container, positioned in a layer opposite the support ring and regulated in such a way that the projecting structure presses cavities into the supporting ring from the interior of the container.

The regulation of at least one of the plurality of production steps can comprise regulating a water content of the pulp and/or a temperature of the pulp. The water content and/or the temperature may concomitantly determine the behavior of the pulp during coating and/or injection distribution and/or during pressing.

The regulation of at least one of the plurality of production steps can comprise regulating a movement of mold parts of the mold after introduction of the fiber-containing pulp for producing a container comprising fibers. By moving the mold parts, regions of the container to be produced may be compressed or stretched before molding.

The regulation of at least one of the plurality of production steps can comprise a regulation of a movement of a spray head for applying the fiber-containing pulp. As a result of the movement of the spray head, distance differences between the spray head and the inner surface of the mold may be compensated for when spraying the fiber-containing pulp.

The regulation of at least one of the plurality of production steps can comprise regulating a spray time, and/or a spray pressure and/or a spray flow (for example by enlarging the cross-section of the spray head or the pulp line to the spray head) of a spray head to a specific position of the mold.

In addition to a wall thickness, a wall density can also be determined.

The regulation of at least one of the plurality of production steps can comprise regulating an inclined arrangement of a mold during a coating process of the fiber-containing pulp. An accumulation of the fiber-containing pulp can accordingly be influenced by the effect of gravity.

If the container is transported into another mold to be squeezed out after the wall thickness has been measured, the pressing force can be regulated in the additional mold on the basis of the wall thickness measurement.

Additionally or alternatively, the wall thickness measurement can be used for regulating the drying. If the containers are dried with air via adjustable drying nozzles, they may be accordingly adjusted in terms of treatment time, treatment temperature or treatment position.

In addition, the regulating of at least one of the plurality of production steps can comprise regulating a composition of the fiber-containing pulp. For example, the pulp can be composed of a plurality of different fibers.

A container comprising fibers which was produced by means of the method for monitoring and regulating a wall thickness distribution in a production process of containers comprising fibers is provided, as described above or further below.

A device is provided for monitoring and regulating a wall thickness distribution in a production process of containers comprising fibers by means of the method, as described above or further below.

A device for monitoring and regulating a wall thickness distribution in a production process of containers comprising fibers can comprise:
a fiber container for providing production material comprising fibers for the containers comprising fibers,
at least one mold for producing the container,
at least one measuring tool for measuring the wall thickness of the container,
a controller for regulating control variables based on the wall thickness measurement.

The device can comprise, for example, a computer-readable storage medium on which instructions for performing the method are stored, and wherein the instructions can be executed, for example, by a processor of the device in order to be able to ensure the monitoring and regulation of a wall thickness distribution in a production process of containers comprising fibers.

A device for producing a container comprising fibers is provided, wherein this device comprises the device for monitoring and regulating a wall thickness distribution in a production process of containers comprising fibers, as described above or further below.

### BRIEF DESCRIPTION OF FIGURES

The accompanying figure show, by way of example, aspects and/or exemplary embodiments of the disclosure for better understanding and illustration. In the figures:

FIG. 1 shows a block diagram for illustrating the monitoring and regulating of a wall thickness distribution in a production process of containers comprising fibers,

FIG. 2 shows an influence of a regulation of a hydraulic pressure of an elastic inner tube on the wall thickness distribution,

FIG. 3 shows an influence of a regulation of a coating and/or injection distribution of pulp on the wall thickness distribution, and

FIG. 4 shows an influence of a regulation of a formation of a hollow support ring on the wall thickness distribution.

### DETAILED DESCRIPTION OF FIGURES

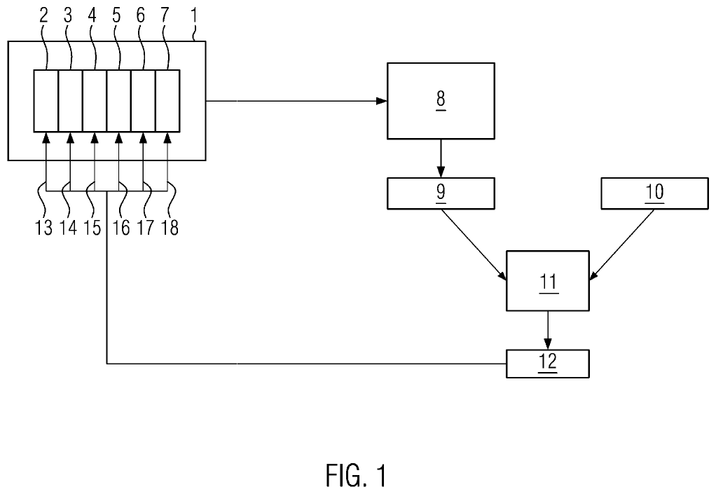

FIG. 1 shows a block diagram for illustrating the monitoring and regulating of a wall thickness distribution in a production process of containers 8 comprising fibers. By means of a device 1, containers 8 comprising fibers may be produced in a production process by running through a plurality of production steps, in this case six production steps 2, 3, 4, 5, 6. A fiber-containing pulp is used to produce the container.

A wall thickness distribution of the produced container 8 is measured in order to obtain a measured wall thickness distribution 9 of the container. A comparison 11 of the measured wall thickness distribution 9 with a target wall thickness distribution 10 is performed. When there is a deviation 12 of the measured wall thickness distribution 9 from the target wall thickness distribution 10, a regulation 13, 14, 15, 16, 17, 18 of at least one of the plurality of production steps 2-6.

A production step 2 can comprise providing fiber-containing pulp. A water content of the pulp and/or a temperature of the pulp may have an influence on the production of the container comprising fibers and its wall thickness distribution. Accordingly, in a regulation 13 of the wall thickness distribution, if a deviation 12 has been detected while monitoring the wall thickness distribution, the water content and/or the temperature may be regulated to bring the measured wall thickness distribution 9 in the subsequently produced containers comprising fibers closer to the target wall thickness distribution 10.

Another production step 3 can comprise introducing the fiber-containing pulp into a mold. The introduction can comprise a coating and/or injection distribution of the pulp. For example, the coating and/or injection distribution can vary along a height and/or a circumference of the container to be produced such that an even distribution of the pulp can be achieved even in containers with a non-round cross-section. Accordingly, a regulation 14 of the coating and/or injection distribution along a height and/or a circumference of the container to be produced can occur if a deviation 12 was determined during the monitoring of the wall thickness distribution, in order to bring the measured wall thickness distribution 9 in the subsequently produced containers comprising fibers closer to the target wall thickness distribution 10. When the pulp is introduced by means of a coating and/or injection distribution, one or more regions may also be provided where multi-coating or multi-injection molding of pulp can occur. Those regions which are not intended to experience multi-coating or multiple injection molding of pulp may be covered during coating and/or injection distribution. If a deviation 12 is detected during the monitoring of the wall thickness distribution, a regulation 14 of a number of coating and/or injection passes can be carried out, and/or a masking of the regions which are not to undergo multiple coatings and/or multiple injections of pulp, in order to bring the measured wall thickness distribution 9 in the subsequently produced containers comprising fibers closer to the target wall thickness distribution 10.

Another production step 15 can comprise pressing the fiber-containing pulp in the mold to shape the container comprising fibers. In this case, a regulation 15 of the pressing force can occur to set a hydraulic pressure of an elastic inner tube when a deviation 12 was determined during the monitoring of the wall thickness distribution, in order to bring the measured wall thickness distribution 9 in the subsequently produced containers comprising fibers closer to the target wall thickness distribution 10.

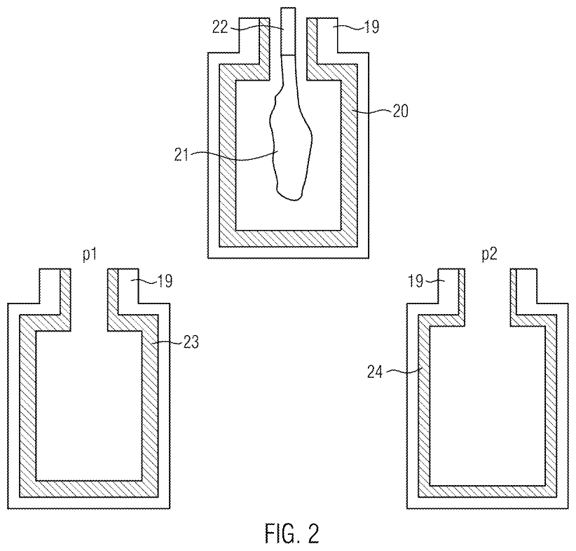

The illustrations in FIG. 2 show the influence of a regulation of a hydraulic pressure of an elastic inner tube 21 on the wall thickness distribution. FIG. 2 shows a mold 19 with inserted pulp 20 which has accumulated on the inner surface of the mold 19. The inner surface of the mold 19 corresponds at least substantially to the outer contour of the container comprising fibers to be produced. An elastic inner tube 21 is introduced into the mold 19, which inner tube is inflatable by means of a compressed air supply 22, as a result of which a pressure can be exerted on the pulp and accordingly can mold the containers comprising the fibers. The greater the hydraulic pressure is selected, the more the pulp can be compressed by the pressure acting thereon. Upper limits of the hydraulic pressure may be given by the elastic inner tube, the shape (e. g., stability) and/or the wall thickness distribution to be achieved, which is to correspond, for example, as closely as possible to a target wall thickness distribution.

By way of example, two illustrations are shown in FIG. 2, bottom left and bottom right, after the hydraulic pressure has been applied to the pulp. A pressure p1 was applied on the left which was smaller than the pressure p2 applied on the right. Accordingly, the pulp 23 in the left mold is compressed to a lesser extent than the pulp 24 in the right mold. The wall thickness distribution of a container comprising fibers which is formed in the left mold can accordingly have a wall thickness distribution whose thickness values in the corresponding regions are greater than in the wall thickness distribution of a container comprising fibers which is formed in the right mold.

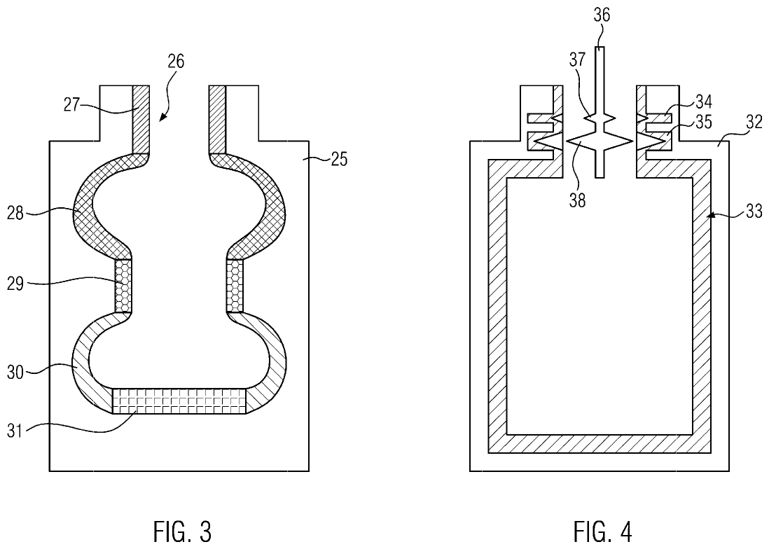

FIG. 3 shows the influence of a regulation of a coating and/or injection distribution of pulp 26. The pulp 26 introduced into a mold 25 by means of a coating and/or injection distribution has a wall thickness distribution which has different thickness values in different regions 27, 28, 29, 30, 31. The pulp 26 has accumulated on the inner surface of the mold 25, wherein the inner surface of the mold 25 corresponds, at least substantially, to the outer contour of the container comprising fibers that is to be produced. For example, the base region 31 can have a first wall thickness distribution with a first thickness value which is greatest. The neck region 27 and a substantially vertically extending first body region 29 may have a second wall thickness distribution with a second thickness value that is smaller than the first value. The curved second body region 28 and third body region 30 may each have a wall thickness distribution with a thickness value increasing from top to bottom, which can lie between the first value and the second value.

FIG. 4 shows the influence of a regulation of a formation of a hollow support ring 34, 35. A mold 32 with introduced pulp 33 is shown which is accumulated on the inner surface of the mold 32. The inner surface of the mold 32 corresponds at least substantially to the outer contour of the container comprising fibers to be produced. The pulp 33 can already have been pressed, for example, with an elastic inner tube introduced into the mold 32, for example by introducing compressed air into the elastic inner tube in order to inflate it. In this way, two support rings may already have been formed in the neck region. In order to then make hollow support rings 34, 35 therefrom, a device 36 can be introduced into the mouth region. The device 36 can comprise two projections 37, 38 of opposite shapes corresponding to the hollow regions to be generated. For example, to act on the pulp of the support rings, the device 36 can be designed to extend radially so that the projections 37, 38 may press into the pulp of the support rings to thereby form the hollow support rings 34, 35.

1. A method for monitoring and regulating wall thickness distribution in a production process of containers comprising fibers, wherein the method comprises:
producing a container comprising fibers by means of a production process comprising a plurality of production steps which uses a fiber-containing pulp or dry fibers,
measuring a wall thickness distribution of the produced container,
comparing the measured wall thickness distribution with a target wall thickness distribution,
when there is a deviation of the measured wall thickness distribution from the target wall thickness distribution, regulating at least one of the plurality of production steps.

2. The method according to claim 1, wherein the regulating of at least one of the plurality of production steps comprises a regulation of pressing force.

3. The method according to claim 2, wherein the pressing force regulation comprises a force regulation of an electric motor for generating a pressing force.

4. The method according to claim 3, wherein the pressing force acts on at least a portion of the container.

5. The method according to claim 3, wherein the regulation of force comprises a regulation of current.

6. The method according to claim 2, wherein the regulation of pressing force comprises a regulation of a hydraulic pressure of an elastic inner tube.

7. The method according to claim 1, wherein the regulation of at least one of the plurality of production steps comprises regulating a coating and/or injection distribution of the pulp.

8. The method according to claim 7, wherein the coating and/or injection distribution can be regulated along a height and/or a circumference of the container.

9. The method according to claim 1, wherein the regulation of at least one of the plurality of production steps comprises a configuration of a hollow support ring.

10. The method according to claim 1, wherein the regulation of at least one of the plurality of production steps comprises regulating a water content of the pulp and/or a temperature of the pulp.

11. The method according to claim 1, wherein the regulation of at least one of the plurality of production steps comprises regulating a movement of mold parts after introduction of the fiber-containing pulp for producing a container comprising fibers.

12. The method according to claim 1, wherein the regulation of at least one of the plurality of production steps comprises regulating a movement of a spray head for applying the fiber-containing pulp.

13. The method according to claim 1, wherein the regulation of at least one of the plurality of production steps comprises regulating an inclined arrangement of a mold during a coating process of the fiber-containing pulp.

14. A container comprising fibers which was produced by means of the method for monitoring and regulating a wall thickness distribution in a production process of containers comprising fibers according to claim 1.

15. A device for monitoring and regulating a wall thickness distribution in a production process of containers comprising fibers, wherein the device comprises:
a fiber container for providing production material comprising fibers for the containers comprising fibers
at least one mold for producing the container
at least one measuring tool for measuring the wall thickness of the container
a controller for regulating control variables based on the wall thickness measurement.

16. The device for monitoring and regulating a wall thickness distribution in a production process of containers comprising fibers by means of the method according to claim 1.

17. A device for producing a container comprising fibers, wherein said device comprises the device according to claim 15.
